(19) United States
(12) Patent Application Publication
(10) Pub. No.: US 2006/0242947 A1
(43) Pub. Date: Nov. 2, 2006

(54) Emission Control System For An Engine

(76) Inventors: Duncan Kay, Brentwood (GB); Gary Peirce, Chelmsford (GB); Marcus Davies, Rochester (GB); Jon Caine, South Woodham Ferrers (GB)

Correspondence Address: FORD GLOBAL TECHNOLOGIES, LLC., FAIRLANE PLAZA SOUTH, SUITE 800, 330 TOWN CENTER DRIVE, DEARBORN, MI, 48126, US

(21) Appl. No.: 11/379,819

(22) Filed: Apr. 24, 2006

(30) Foreign Application Priority Data
Apr. 28, 2005 (GB) 0508637.6

(51) Int. Cl. F02M 25/06; F01N 3/00

(52) U.S. Cl. 60/284; 60/279; 60/286

(57) ABSTRACT

An emission control system for an engine is disclosed in which an exhaust gas cooler is positioned upstream from a hydrocarbon trap in order to prevent premature desorbtion of hydrocarbons from the hydrocarbon trap. A bypass passage is also provided to allow the exhaust gas cooler to be bypassed to speed up the activation of a lean NOx trap positioned downstream from the hydrocarbon trap prior to hydrocarbon release.

### FIELD OF THE INVENTION

This invention relates to internal combustion engines and in particular to an emission control system for an internal combustion engine providing reduced hydrocarbon emissions during engine warm up.

### BACKGROUND AND SUMMARY OF THE INVENTION

It is well known to provide an internal combustion engine with an emission control system having a catalyst to reduce hydrocarbon emissions from the engine during running of the engine.

However, it is a problem with a conventional emission control system that hydrocarbon emission are produced as soon as the engine starts but a conventional catalyst is unable to convert these emissions until it has reached a predetermined temperature normally referred to as its light-off temperature. There is therefore a period of time after start-up from cold during which hydrocarbon emissions are very high until the catalyst becomes active.

It has therefore been proposed in, for example U.S. Pat. No. 5,937,637, to incorporate a hydrocarbon trap in the emission control system in order to absorb these hydrocarbons during the period of initial warm up.

Such devices use Zeolites such as moldenite or a Y type zeolite which are very effective at absorbing hydrocarbons below a first or storage temperature, limit that is normally in the range of 150 to 180° C., and then automatically release the trapped hydrocarbons when the temperature exceeds this storage temperature limit.

One disadvantage of the system proposed in U.S. Pat. No. 5,937,637 is that a separate air injection apparatus is used which adds not only to the cost of the powertrain but also to its complexity and the difficulty of accommodating the powertrain within the confines of a small engine bay.

It is further known from U.S. Pat. No. 5,184,462 to provide a system in which a hydrocarbon absorbing material is applied to the surfaces of an exhaust gas cooler so as to provide some hydrocarbon trapping. It is a problem with such an arrangement that the exhaust gasses impinge directly against the hydrocarbon absorbing material and so it is difficult to maintain the absorbing material at a uniform temperature below that required for absorbtion with no desorbtion. In effect, there will always be a temperature gradient between the hot exhaust gasses and the coolant flowing through the cooler such that the surface of the absorbing material is close to the temperature of the exhaust gasses impinging there against.

Accordingly, the present invention provides an improved emission control system for an engine that overcomes disadvantages of the above-mentioned prior art.

According to a first aspect of the invention, there is provided an emission control system for an internal combustion engine comprising an exhaust gas cooler arranged to receive a supply of exhaust gasses from the engine, a hydrocarbon trap located downstream from the exhaust gas cooler such that the exhaust gas cooler and the hydrocarbon trap form a first exhaust gas flow path, a bypass passage connected between a first position located upstream of the exhaust gas cooler to a second position located downstream from the hydrocarbon trap so as to form a second exhaust gas flow path and at least one control valve to control the flow of exhaust gasses through the first and second exhaust gas flow paths.

The emission control system may be operable such that, at least when the temperature of the exhaust gasses is below a first predetermined temperature, each control valve is operable to cause the exhaust gasses to flow through the first exhaust gas flow path.

There may be a single control valve located at the second position downstream from the hydrocarbon trap.

Alternatively, there may be a single control valve located at the first position upstream from the exhaust gas cooler.

Advantageously, the exhaust gas cooler and the hydrocarbon trap may be mounted within the same housing.

Preferably, the exhaust gas cooler and the hydrocarbon trap are mounted within a common housing and the bypass passage is formed within the common housing.

The emission control system may further comprise a three way catalyst located upstream from the first position.

The three way catalyst may be coupled to an exhaust manifold of the engine.

The first predetermined temperature may be a temperature sufficiently high to produce light-off of the three way catalyst.

The emission control system may be operable such that, when the temperature of the exhaust gasses is above the first predetermined temperature but below a second predetermined temperature, each control valve is operable to cause the exhaust gasses to flow through the second exhaust gas flow path.

The emission control system may be operable such that, when the temperature of the exhaust gasses are above a second predetermined temperature, each control valve is operable to control the flow through the first and second flow paths so as to maintain the temperature of the exhaust gasses downstream from the second position within a predetermined temperature range.

The emission control system may further comprise a secondary catalytic device located downstream from the second position.

The second predetermined temperature may be a temperature sufficiently high to produce light-off of the secondary catalytic device.

The secondary catalytic device may be a lean NOx trap.

In which case, the predetermined temperature range may be a range of temperatures bounded at its lower end by a temperature below which the efficiency of the lean NOx trap falls below a desired NOx conversion efficiency and at its upper end by a temperature above which the NOx conversion efficiency of the lean NOx trap falls below a desired efficiency.

The exhaust gas cooler may be arranged to receive in use a supply of coolant from a main cooling circuit of the engine.

The position of each control valve may be controlled by an electronic control unit based upon one or more temperatures.

The temperature may be derived by at least one of direct measurement using one or more temperature sensors and temperature modelling.

According to a second aspect of the invention there is provided an internal combustion engine having an emission control system in accordance with said first aspect of the invention.

According to a third aspect of the invention, there is provided a method for reducing hydrocarbon emissions from an engine having an emission control system comprising a three way catalytic converter close coupled to an exhaust manifold of the engine so as to receive exhaust gasses therefrom, an exhaust gas cooler arranged to receive a supply of exhaust gasses from the three way catalyst, a hydrocarbon trap located downstream from the exhaust gas cooler such that the exhaust gas cooler and the hydrocarbon trap form a first exhaust gas flow path, a bypass passage connected between a first position located upstream of the exhaust gas cooler to a second position located downstream from the hydrocarbon trap so as to form a second exhaust gas flow path, and a secondary catalytic device located downstream from the second position wherein the method comprises measuring the temperature of the exhaust gasses from the engine and, at least when the temperature of the exhaust gasses leaving the engine is below a first predetermined temperature, causing the exhaust gasses to flow through the first exhaust gas flow path.

The first predetermined temperature may be a light-off temperature of the close coupled three way catalyst.

The method may further comprise operating control valves to cause the exhaust gasses to flow through the second exhaust gas flow path when the temperature of the exhaust gasses is above the first predetermined temperature but below a second predetermined temperature.

The second predetermined temperature may be the light-off temperature of the secondary catalytic device.

The secondary catalytic device may be a lean NOx trap.

The method may further comprise operating the or each control valve to control the flow through the first and second flow paths so as to maintain the temperature of the exhaust gasses downstream from the second position within a predetermined temperature range when the temperature of the exhaust gasses are above the second predetermined temperature.

The predetermined temperature range may be a range of temperatures bounded at its lower end by a temperature below which the NOx conversion efficiency of the lean NOx trap falls below a desired efficiency and at its upper end by a temperature above which the NOx conversion efficiency of the lean NOx trap falls below a desired efficiency.

The above advantages and other advantages, and features of the present invention will be readily apparent from the following detailed description of the preferred embodiments when taken in connection with the accompanying drawings, and from the claims.

### BRIEF DESCRIPTION OF THE DRAWINGS

The invention will now be described by way of example with reference to the accompanying drawing of which:

FIG. 1 is a diagrammatic representation of a preferred embodiment of an emission control system including an exhaust gas cooler and hydrocarbon trap according to the invention;

FIG. 2 is a first alternative embodiment of an exhaust gas cooler and hydrocarbon trap for use in an emission control system according to the invention; and

FIG. 3 is a second alternative embodiment of an exhaust gas cooler and hydrocarbon trap for use in an emission control system according to the invention.

### DESCRIPTION OF PREFERRED EMBODIMENT(S)

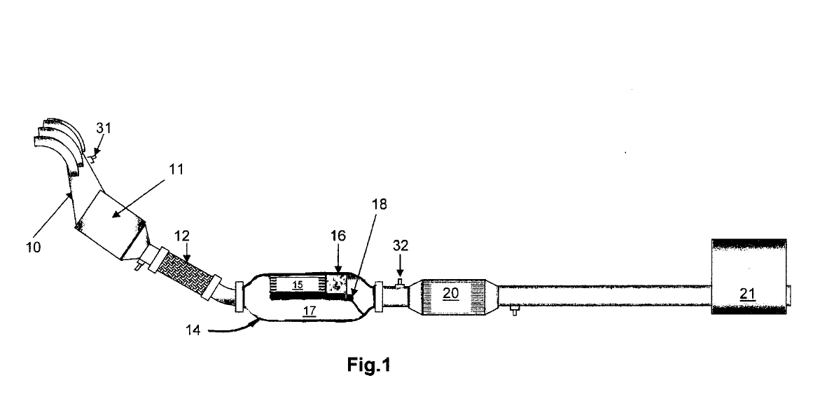

With particular reference to FIG. 1 there is shown an emission control system for a lean burn internal combustion engine (not shown). It will however be appreciated that the invention is equally applicable to non-lean burn engines and diesel engines.

The emission control system comprises of a three way catalyst 11 which is coupled to an exhaust manifold 10 of the engine, a combined exhaust gas cooler and hydrocarbon trap unit 14 and a lean NOx trap 20. Such a three way catalyst is often referred to as a close coupled catalyst due to its location close to the exhaust outlets from the engine.

The three way catalyst 11 is coupled via a flexible tube 12 to the combined exhaust gas cooler and hydrocarbon trap unit 14. The combined exhaust gas cooler and hydrocarbon trap unit 14 has an outlet which is coupled to the downstream mounted lean NOx trap 20. Exhaust gasses from the lean NOx trap 20 flow to a silencer unit 21 and then out to atmosphere via a tailpipe (not shown).

The combined exhaust gas cooler and hydrocarbon trap unit 14 comprises of a common housing or can which defines two separate flow paths.

In a first of these flow paths is mounted a water cooled exhaust gas cooler 15 and a hydrocarbon trap 16. The hydrocarbon trap 16 is located downstream from the exhaust gas cooler 15 so that all of the exhaust gasses passing through the hydrocarbon trap 16 have previously been cooled by the exhaust gas cooler 15 and therefore the hydrocarbon trap 16 is never exposed to the full exhaust gas temperature entering the combined exhaust gas cooler and hydrocarbon trap unit 14. A second flow path forms a bypass passage 17 which extends between a location upstream from the exhaust gas cooler 15 to a position downstream from the hydrocarbon trap 16.

The exhaust gas cooler 15 is connected to a main cooling circuit (not shown) of the engine from where it receives a supply of engine coolant. The coolant flows through the exhaust gas cooler 15 and then is returned to the main engine cooling circuit. The exhaust gas cooler 15 is therefore able to recover some of the heat from the exhaust gasses and return it to the main cooling circuit. This is advantageous after starting the engine from cold as it speeds up engine warm up thereby reducing engine warm up emissions, increasing warm up fuel economy and improving cabin heater performance.

A control valve 18 is used to control the flow of exhaust gasses through the first and second flow paths. In the example shown a simple flap valve is shown but it will be appreciated that any suitable valve could be used.

In FIG. 1, the control valve 18 is shown downstream from the hydrocarbon trap 16 at the second position but it will be appreciated that it could alternatively be located upstream from the exhaust gas cooler 15 at the first position. The position shown is preferred because, if for any reason there is any hydrocarbon leakage from the hydrocarbon trap 16, this leakage cannot flow downstream to the lean NOx trap 20 while the control valve 18 is blocking the exit from the first flow path. In addition, the control valve 18 if so positioned is exposed to lower temperatures, at least when the exhaust gasses are flowing through the exhaust gas cooler 15, and so a more economical form of control valve can be used.

The control valve 18 in the example provided is vacuum actuated via a vacuum actuator (not shown), which is controlled by an electronic control unit (not shown). It will however be appreciated that the valve could be actuated in some other way by the electronic control unit.

The electronic control unit receives several inputs including a measurement of air/fuel ratio from an oxygen sensor 31, a measurement of temperature at a position close to an inlet to the lean NOx trap 20 from a temperature sensor 32. These inputs may be used by the electronic control unit to control the position of the control valve 18.

As soon as the engine is started, the electronic control unit begins to receive a signal from the temperature sensors 32. If the engine has been started from cold after a prolonged period of inactivity, it is likely that the three way catalyst 11 will be substantially at ambient temperature and hence considerably below its light-off temperature of approximately 250 to 350° C. Under these conditions, the three way catalyst 11 will have very little reducing effect on hydrocarbon emissions, and so it is desirable that all of the exhaust gasses pass through the hydrocarbon trap 16.

The electronic control unit is therefore programmed to operate or move the control valve 18 to a position in which the flow of exhaust gasses through the second flow path or bypass passage 17 is blocked (as shown in FIG. 1), but the flow of exhaust gasses through the first flow path is unrestricted until either the light-off temperature of the three way catalyst 11 has been achieved or the temperature of the hydrocarbon trap is too high. These temperatures can be predicted using temperature modelling or by using the input from the temperature sensor 32. It will be appreciated that it would be possible to produce a modelled system temperature for use by the electronic control unit so that no temperature sensor ids required.

In this configuration, the exhaust gasses will flow through the exhaust gas cooler 15 and then through the hydrocarbon trap 16 where any hydrocarbons in the exhaust gasses will be absorbed before flowing on through the lean NOx trap 20 and the silencer 21 to atmosphere. The function of the exhaust gas cooler 15 during this phase of operation is to make sure that the temperature of the exhaust gasses reaching the hydrocarbon trap 16 is kept below the temperature at which hydrocarbons are desorbed or released from the hydrocarbon trap 16. This temperature will depend upon the material used for the hydrocarbon trap 16 but is likely to be in the range of 150 to 180° C.

As the engine continues to operate, the temperature of the exhaust gasses exiting the three way catalyst will continue to increase until after a certain period of time has elapsed they will reach the first predetermined temperature and the three way catalyst 11 will begin to significantly reduce the hydrocarbon emissions from the engine. It will be appreciated that the three way catalyst 11 will not be operating at peak conversion efficiency at this temperature but it will have achieved sufficient conversion efficiency to dispense with the absorbing properties of the hydrocarbon trap 16. This event will occur approximately 30 to 50 seconds after initial engine start-up from cold if the engine is operated according to a typical emission test cycle.

It is now important to light-off the lean NOx trap 20 as quickly as possible. To do this, the temperature of the exhaust gasses reaching the lean NOx trap 20 needs to be as high as possible. The electronic control unit is therefore programmed to operate or move the control valve 18 to a position in which no flow is permitted through the first flow path but unrestricted flow is permitted through the second flow path constituted by the bypass passage 17 when the exhaust gas temperature is sensed to be above the first predetermined temperature but below a second predetermined temperature representing the light-off temperature of the lean NOx trap 20. During this phase of operation, the maximum available exhaust gas temperature is supplied to the lean NOx trap 20 to heat it rapidly and no cooling is supplied by the exhaust gas cooler 15 to the exhaust gasses.

The first and second predetermined temperatures used by the electronic control unit can be determined by modelling using data created by test bed running, be based upon the temperature sensor 32 or be obtained by a combination of these. It will be appreciated that these temperatures correspond to the temperatures of the close coupled catalyst 11 and the lean NOx trap 20 at which light-off of these devices occur.

During the period that the lean NOx trap 20 is warming up to its light-off temperature, the temperature of the exhaust gasses from the engine will continue to rise and this will continue after the lean NOx trap 20 has reached its light-off temperature. As is well known in the art, lean NOx traps are temperature sensitive and have a range of operating temperatures in which they are most efficient and also are adversely affected by temperatures above a maximum service temperature. Running with exhaust gas temperatures above the maximum service temperature will result in premature ageing of a lean NOx trap and a significant reduction in its effective service life. It is therefore desirable to keep a lean NOx trap operating within its most efficient operating range or at least ensure that the temperature of the exhaust gasses entering the lean NOx trap 20 are kept below the maximum service temperature for as much of the time as possible.

One of the advantages of this invention is that the exhaust gas cooler 15 is able to perform two separate but useful roles when a lean NOx trap is used in the system.

In the first of these roles, it maintains the hydrocarbon trap 16 below the temperature at which hydrocarbons are desorbed from the hydrocarbon trap thereby allowing the hydrocarbon trap 16 to continue absorbing hydrocarbons for some time after the exhaust gas temperature exiting the engine has exceeded the de-absorbing temperature. This means that the hydrocarbon trap 16 can continue to absorb hydrocarbons until the three way catalyst has begun to operate efficiently and so there is no period during the initial period of running when excessive hydrocarbon emissions are vented to atmosphere due to inactive or low efficiency operation of the three way catalyst or leakage from the hydrocarbon trap due to desorbtion.

In the second role, it acts so as to minimise excursions above the maximum service temperature of the lean NOx trap 20 and to maintain, so far as is possible, the temperature of the exhaust gasses entering the lean NOx trap 20 within the range of temperatures where the lean NOx trap 20 will operate most efficiently.

To achieve this second role, the electronic controller is operable to control the position of the control valve 18 so as to maintain the temperature of the exhaust gasses within a predetermined range of temperatures which in its broadest sense could be bounded by the light-off temperature of the lean NOx trap 20 and the maximum preferred operating temperature of the lean NOx trap 20 but in practice is a range of temperatures in which the lean NOx trap 20 will operate above a predetermined level of efficiency.

For example, if the light-off temperature is 275° C. and the maximum preferred operating temperature is 650°, then the lean NOx trap 20 may have a temperature range of 300 to 450° C. in which it operates at an optimum efficiency.

If the temperature of the exhaust gasses entering the lean NOx trap 20 reaches the upper efficiency temperature limit, the control valve 18 will be moved into a position to force more of the exhaust gasses to pass through the exhaust gas cooler 15 so as to reduce the temperature of the exhaust gasses reaching the lean NOx trap 20. But if the temperature of the exhaust gasses entering the lean NOx trap 20 reaches the lower efficiency limit, then the control valve 18 will be moved by the electronic control unit to restrict the flow of exhaust gasses through the exhaust gas cooler 15 and permit more of the exhaust gasses to flow through the bypass passage 17, thereby increasing the temperature of the exhaust gasses reaching the lean NOx trap 20. In this way, the efficiency of the lean NOx trap 20 is kept as close to an optimum efficiency as is possible by using the control valve 18 as a mixing valve.

It will be appreciated that the cooling capacity of the exhaust gas cooler 15 may not be sufficient to maintain the exhaust gas temperature within this range at all times and that in practice there may even be periods when the maximum service temperature of the lean NOx trap 20 will be exceeded. These periods are when the engine is running at high speed at maximum or close to maximum load. During these periods of running, the exhaust gas temperature will rise considerably and it may not be practical to provide an exhaust gas cooler large enough to maintain the lean NOx trap 20 within its preferred operating range. This is because the cooling capacity of the exhaust gas cooler 15 is dependent upon its size and there will be a restriction on the size of exhaust gas cooler that can be fitted to a motor vehicle. In addition, the use of a very large exhaust gas cooler will have an effect on the main cooling circuit of the engine. This is because the heat transferred into the main cooling circuit from the exhaust gas cooler 15 has to be dissipated by a radiator forming part of the main cooling circuit. If the quantity of heat transferred is increased, then the size of the radiator used in the main cooling circuit will need to be larger. This can be a problem if a larger radiator cannot be accommodated on the vehicle.

However, during lean burn operation of the engine, the exhaust gas temperatures produced are lower than when the engine is operating at or close to full power and the capacity of the exhaust gas cooler is normally sufficient to maintain the temperature of the exhaust gasses entering the lean NOx trap 20 within the preferred range. It will be appreciated that if the temperature of the exhaust gasses exceeds the upper limit of the preferred temperature range, the control valve 18 will remain in a position preventing the flow of exhaust gasses through the bypass passage 17 so as to maximise the cooling effect and keep the exhaust gas temperature entering the lean NOx trap 20 as low as possible given the capacity limitations of the exhaust gas cooler 15 and the vehicle cooling system.

It will be appreciated that when the electronic control unit operates the control valve 18 as a mixer valve to maintain the temperature entering the lean NOx trap 20 within a predetermined range, the temperature of the exhaust gasses passing through the hydrocarbon trap 16 may exceed the temperature at which desorbtion will occur. Hydrocarbons will then be released from the hydrocarbon trap 16, thereby emptying the hydrocarbon trap 16 and preparing it for re-use. This desorbtion will not produce an increase in tailpipe hydrocarbon emissions because the released hydrocarbons will react with the platinum group metals used in the lean NOx trap 20 which is already operating efficiently and through which all of the released hydrocarbons must pass. That is to say, the lean NOx trap 20 acts as a secondary catalyst during this phase of operation.

One of the features of the invention is that the hydrocarbon trap 16 is simply that, it traps and then releases hydrocarbons. This means that no platinum group metals have to be used in its construction. This significantly reduces the cost of manufacture of the hydrocarbon trap and, because of the blocking effect that platinum group metals have on the zeolites used in a hydrocarbon trap, increases the effective storage capacity per unit volume of the hydrocarbon trap 16. Platinum group metals are not required because the lean NOx trap 20 is used as a catalyst as described above.

Although the invention has been described with reference to the use of a lean NOx trap downstream, it will be appreciated that for non-lean burn engines the lean NOx trap could be replaced by a secondary three way catalyst.

Because current emission regulations are very strict, emission performance during start-up is a problem and so conventional emission control systems tend to use high platinum group metal loadings in the close coupled three way catalyst to reduce the time at which light-off is achieved. There is also a tendency to use extended periods during which the engine is run inefficiently in order to produce rapid warm up of the three way catalyst not only to light-off but also to a temperature where it is operating close to peak efficiency.

Other advantages of the invention are that the loading of platinum group metals in the close coupled catalyst can be significantly reduced by using an emission control system according to the invention because it is no longer essential to light-off the three way catalyst as soon as possible as hydrocarbons are trapped by the hydrocarbon trap 16. In addition, the presence of the exhaust gas cooler 15 means that this process of trapping will continue for a longer period of time than would be possible if no exhaust gas cooler 15 is fitted because the temperature of the exhaust gasses reaching the hydrocarbon trap 16 are kept below the desorbtion temperature for a longer period of time. In fact, the hydrocarbon trap is able to hold trapped hydrocarbons until both the three way catalyst and the lean NOx trap are lit-off.

Similarly, inefficient engine operation can be terminated as soon as the three way catalyst is lit-off and does not need to be continued. This is because the hydrocarbon trap 16 will still be trapping hydrocarbons during this phase of operation and so it is not essential that the three way catalyst reaches peak efficiency as soon as is practicable. This increases fuel economy during this period.

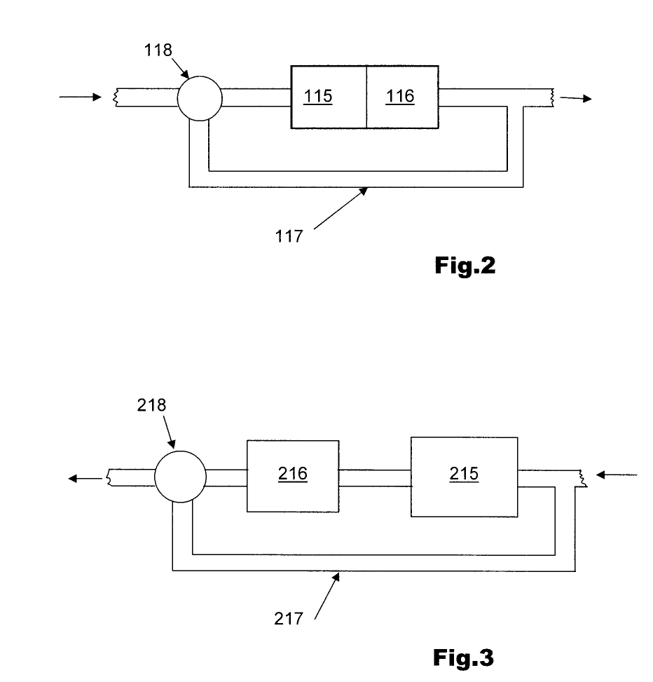

With reference to FIG. 2, there is shown an exhaust gas cooler and hydrogen trap arrangement that is intended to be a direct replacement for the combined exhaust gas cooler and hydrocarbon trap unit 14 shown in FIG. 1

As before, there is a control valve 118 to control the flow of exhaust gasses through two separate flow paths. In the first of these flow paths are located an exhaust gas cooler 115 and a hydrocarbon trap 116 which are both mounted in a common housing. As before, the hydrocarbon trap is mounted downstream from the exhaust gas cooler 115 so that any exhaust gas reaching the hydrocarbon trap 116 has been cooled by the exhaust gas cooler 115.

The second flow path is formed by a bypass passage 117 which in this case is formed as a separate tube. The bypass passage 117 extends from a first position upstream of the exhaust gas cooler 115 to a second position downstream from the hydrocarbon trap 116. The control valve 118 is located at the first position and, as before, is controlled by an electronic control unit (not shown) to regulate the flow of exhaust gasses through the first and second flow paths.

Operation is exactly as previously described and so will not be described again.

With reference to FIG. 3, there is shown yet one more exhaust gas cooler and hydrogen trap arrangement that is intended to be a direct replacement for the combined exhaust gas cooler and hydrocarbon trap unit 14 shown in FIG. 1

As before, there is a control valve 218 to control the flow of exhaust gasses through two separate flow paths. In the first of these flow paths are located an exhaust gas cooler 215 and a hydrocarbon trap 216, each of which is mounted in a separate housing. As before, the hydrocarbon trap 216 is mounted downstream from the exhaust gas cooler 215 so that any exhaust gas reaching the hydrocarbon trap 216 has been cooled by the exhaust gas cooler 215.

The second flow path is formed by a bypass passage 217 which is formed as a separate tube. The bypass passage 217 extends from a first position upstream of the exhaust gas cooler 215 to a second position downstream from the hydrocarbon trap 216. The control valve 218 is located at the second position and as before is controlled by an electronic control unit (not shown) to regulate the flow of exhaust gasses through the first and second flow paths.

Operation is exactly as previously described with reference to FIG. 1 and so will not be described again.

Although in the previous examples the invention has been described with reference to a single valve located upstream of the exhaust gas cooler or downstream from the hydrocarbon trap, it will be appreciated that more than one control valve could be used to control the flow through the two flow paths.

A further advantage of this invention is that if a close coupled three way catalyst is used, then the hydrocarbon trap only has to absorb hydrocarbons for a short period of time while the three way catalyst heats up. After that, most of the hydrocarbon emissions from the engine will be dealt with by the three way catalyst. This means that the storage capacity of the hydrocarbon trap can be relatively small.

Therefore, in summary, the invention provides in a preferred embodiment an emission control system that is able to absorb hydrocarbons in a hydrocarbon trap without reaching a desorbtion temperature for a short period of time following start-up to permit a close coupled three way catalyst to begin operation and then divert exhaust gasses so as to rapidly heat a secondary catalytic device so as to light-off the secondary catalytic device and then use the secondary catalytic device to process the hydrocarbons stored in the hydrocarbon trap, thereby eliminating the need for the hydrocarbon trap to have any catalytic properties.

It will be appreciated by those skilled in the art that although the invention has been described by way of example with reference to one or more embodiments it is not limited to the disclosed embodiments and that modification to the disclosed embodiments or alternative embodiments could be constructed without departing from the scope of the claims:

1. An emission control system for an internal combustion engine, comprising:
an exhaust gas cooler arranged to receive a supply of exhaust gasses from the engine;
a hydrocarbon trap located downstream of said exhaust gas cooler such that said exhaust gas cooler and said hydrocarbon trap form a first exhaust gas flow path;
a bypass passage connected between a first position located upstream of said exhaust gas cooler to a second position located downstream from said hydrocarbon trap so as to form a second exhaust gas flow path;
and at least one control valve to control the flow of exhaust gasses through said first and said second exhaust gas flow paths.

2. The emission control system as claimed in claim 1 wherein when a temperature of said exhaust gasses is below a first predetermined temperature, the or each control valve is operable to cause said exhaust gasses to flow through said first exhaust gas flow path.

3. The emission control system as claimed in claim 2 wherein there is a single control valve located at said second position downstream of said hydrocarbon trap.

4. The emission control system as claimed in claim 2 wherein there is a single control valve located at said first position upstream from said exhaust gas cooler.

5. The emission control system as claimed in claim 4 wherein said exhaust gas cooler and said hydrocarbon trap are mounted within the same housing.

6. The emission control system as claimed in claim 5 wherein said exhaust gas cooler and said hydrocarbon trap are mounted within a common housing and a bypass passage is formed within said common housing.

7. The emission control system as claimed in claim 6 wherein said emission control system further comprises a three way catalyst located upstream of said first position.

8. The emission control system as claimed in claim 7 wherein said three way catalyst is coupled to an exhaust manifold of the engine.

9. The emission control system as claimed in claim 8 wherein said first predetermined temperature is a temperature sufficiently high to produce light-off of said three way catalyst.

10. The emission control system as claimed in claim 9 wherein, when said temperature of said exhaust gasses is above said first predetermined temperature but below a second predetermined temperature, the or each control valve is operable to cause said exhaust gasses to flow through said second exhaust gas flow path.

11. The emission control system as claimed in claim 9 wherein, when said temperature of said exhaust gasses is above a second predetermined temperature, the or each control valve is operable to control the flow through the first and second flow paths so as to maintain the temperature of the exhaust gasses downstream from said second position within a predetermined temperature range.

12. The emission control system as claimed in claim 11 wherein said emission control system further comprises a secondary catalytic device located downstream from said second position.

13. The emission control system as claimed in claim 12 wherein said second predetermined temperature is a temperature sufficiently high to produce light-off of said secondary catalytic device.

14. The emission control system as claimed in claim 13 wherein said secondary catalytic device is a lean NOx trap.

15. The emission control system as claimed in claim 14 wherein said predetermined temperature range is a range of temperatures bounded at its lower end by a temperature below which the efficiency of said lean NOx trap falls below a desired NOx conversion efficiency and at its upper end by a temperature above which a NOx conversion efficiency of said lean NOx trap falls below a desired efficiency.

16. The emission control system as claimed in claim 15, wherein said exhaust gas cooler is arranged to receive in use a supply of coolant from a main cooling circuit of the engine.

17. The emission control system as claimed in claim 16 wherein the position of the or each control valve is controlled by an electronic control unit based upon one or more temperatures.

18. The emission control system as claimed in claim 17 wherein the or each temperature is derived by at least one of direct measurement using one or more temperature sensors and temperature modelling.

20. The method for reducing hydrocarbon emissions from an engine having an emission control system having a three way catalytic converter close coupled to an exhaust manifold of the engine so as to receive exhaust gasses therefrom, an exhaust gas cooler arranged to receive a supply of exhaust gasses from the three way catalyst, a hydrocarbon trap located downstream from the exhaust gas cooler such that the exhaust gas cooler and the hydrocarbon trap form a first exhaust gas flow path, a bypass passage connected between a first position located upstream of the exhaust gas cooler to a second position located downstream from the hydrocarbon trap so as to form a second exhaust gas flow path, and a secondary catalytic device located downstream from the second position, the method comprising:
measuring a temperature of the exhaust gasses from the engine;
and causing the exhaust gasses to flow through the first exhaust gas flow path when said temperature of the exhaust gasses is below a first predetermined temperature.

21. The method as claimed in claim 20 wherein the first predetermined temperature is a light-off temperature of the close coupled three way catalyst.

22. The method as claimed in claim 21 further comprising operating control valves to cause the exhaust gasses to flow through the second exhaust gas flow path when said temperature of the exhaust gasses is above said first predetermined temperature but below a second predetermined temperature.

23. The method as claimed in claim 22 wherein said second predetermined temperature is the light-off temperature of the secondary catalytic device.

24. A method as claimed in any of claim 22 wherein the secondary catalytic device is a lean NOx trap.

25. A method as claimed in claim 24 further comprising operating the or each control valve to control the flow through the first and second flow paths so as to maintain said temperature of the exhaust gasses downstream from the second position within a predetermined temperature range when the temperature of the exhaust gasses are above the second predetermined temperature.

26. The method as claimed in claim 25 wherein the predetermined temperature range is a range of temperatures bounded at its lower end by a temperature below which a NOx conversion efficiency of said lean NOx trap falls below a desired efficiency and at its upper end by a temperature above which a NOx conversion efficiency of said lean NOx trap falls below a desired efficiency.
